(19) United States
(12) Patent Application Publication
(10) Pub. No.: US 2019/0073602 A1
(43) Pub. Date: Mar. 7, 2019

(54) DUAL CONSEX WARNING SYSTEM

(71) Applicant: Dual Stream Technology, Inc., Santa Cruz, CA (US)

(72) Inventor: Leopold B. Willner, Santa Cruz, CA (US)

(21) Appl. No.: 16/122,709

(22) Filed: Sep. 5, 2018

Related U.S. Application Data
(60) Provisional application No. 62/605,991, filed on Sep. 6, 2017.

(51) Int. Cl. G06N 5/04; G08B 21/18

(52) U.S. Cl. CPC G06N 5/048; G06N 5/043; G08B 21/187

(57) ABSTRACT

Methods and systems consistent with the present disclosure identify useful ways or means of comparing and contrasting information from automated systems as compared to human inputs when identifying potential weaknesses in designs or other methods. This disclosure is also associated with identifying apparatus/systems and methods that combine the skills of humans at sensing and understanding unusual situations with the capabilities of machines and artificial intelligence (AI) to create a better more reliable type of warning system for practical application when attempting to improve outcomes, especially in situations where a high consequence is associated with a low probability. These systems and methods may also be useful in conditions where a negative outcome is associated with a high probability and where new perspectives can identify or lead to solutions or warnings that may lead to a positive outcome when those new perspectives are associated with a low or unknown success probability.

### CROSS REFERENCE TO RELATED APPLICATIONS

The present invention claims priority benefit of U.S. provisional application No. 62/605,991 filed on Sep. 6, 2017 entitled “Dual Consex Warning System” the disclosure of which is incorporated by reference.

### BACKGROUND OF THE INVENTION

### Field of the Invention

The present invention is generally directed to methods and apparatus associated with intelligent systems. More specifically, the present invention is directed to computerized methods and systems that use contrasting information when identifying when warnings should be generated.

### Description of the Related Art

Methods for identifying best modes of medical treatments or for identifying weakness in designs are subject to bias. Individuals, organizations, and forms of machine intelligence suffer from bias and assumptions that may cause those individuals, organizations, or intelligent machines to make conclusions that are not correct or that diverge from each other. Such bias when applied to medical treatments or to engineering design may lead to catastrophic failure because the perspectives of any person, entity, or machine are constrained to protocols and/or assumptions that may miss significant important possibilities that could cause doctors to miss diagnose an ailment or that could miss reviewing important design constraints in an engineered system.

For example, an individual went to the doctor with symptoms consistent with sciatica (pains that extended from the hip down a leg). The doctors immediately focused in on the perceived fact that the patient was suffering from sciatica and performed a series of tests to test this hypothesis. These tests included taking an X-ray of the back starting near the upper hip, looking for potential herniated disks or bone spurs. When the tests were inconclusive, the doctors continued with treatment consistent with treating sciatica. As the patient's health continued to deteriorate, the doctors performed additional tests that identified that the patient really was suffering from bone cancer and had a malignant tumor in his upper leg. This necessitated amputation of the leg. Since the cancer was not caught in time, the patient's health continued to deteriorate until he passed away. When a retrospective analysis of the initial X-ray was performed, a shadow could be seen where the tumor resided. The doctors missed the possibility that this patient had bone cancer even when they may have been able to identify an anomaly in the X-ray that could have led them to perform more tests that could have let them discover the cancer months earlier. In this case the doctors suffered from bias that sciatica symptoms must be related to sciatica. In fact, a small percentage of patients with sciatica symptoms really have a tumor.

Another example relates to the Challenger space shuttle disaster, where cold ‘leaky’ O-rings were later blamed for causing exhaust gas to escape from the side of a solid fuel booster causing these hot gassed to cut into the main fuel tank, resulting in the explosion of the Challenger space craft. While this may have been largely the fault of management, who wished to launch under pressure, the failure was also linked to the management not being sufficiently warned of the dangers of launching the space shuttle at cold temperatures.

In yet another example, forensic analysis after the airplane of Jon Jon Kennedy crashed, killing him, his wife, and his sister in law, indicated that Jon Jon became disoriented when flying in fog, leading him to fly upside down and crash into the ocean. Since human perspectives can become confused, as in this case, a second system to compare and contrast with human cognition could have save Jon Jon and his companions by warning Jon Jon that he was really flying upside down.

Historically, ever since the dawn of humanity, the human species has benefited from the ability of applying the human mind to solving problems that affect humanity. Because of various factors that include human reason, the ability that humanity has to develop tools and the ability to pass knowledge from generation to generation, the human species has become the most powerful species on planet Earth. The human species has also domesticated various other species, such as horses, dogs, and elephants and has used these other species in symbiotic relationships.

Recently, the human species has begun to create new forms of intelligence in the form of intelligent machines. Commonly referred to as artificial intelligence (AI), intelligent machines come in forms that include computer modeling software, stochastic engines, neural networks, and fuzzy logic. These intelligent machines operate in fundamentally different ways than do the minds of organic species like humans because humans are part logical and part emotional in nature, where AI machines are more computational and are devoid of emotion. This means that people that are members of the human species and AI machines are members of the machine species are alien to each other.

In recent years, AI has been harnessed to perform speech recognition, identify individuals using biometric information (such as fingerprints and retinal scans), play games like chess, and to perform tasks like facial recognition. In these applications, machine intelligence often outperforms humans because the problems associated with interpreting speech, identifying biometric markers, and playing games have a limited or fixed set of rules and because modern computers can perform calculations directed to a limited or fixed set of rules much faster than humans can.

As such, in some applications, machine intelligence is able to perform tasks with a greater degree of accuracy, proficiency, or speed then can be performed by a member of the human species. In yet other instances, human intelligence can perform tasks or make evaluations better than machines can. For example, humans are better than machines at interpreting body language or emotional quest associated with other humans. Humans are also better at performing tasks where an equation cannot be applied to solve a problem that has an emotional component or that has a context that a machine cannot understand.

AI has also been used to identify trends using collected data. In certain instances, this data may be related to a demographic of humans. For example, the chances of a white male to vote Republican or Democratic may be related to age, yet may also be related to zip code, profession, or other pieces of demographic information. Similarly, the propensity for a doctor that has been trained or that is constrained by the health care system to evaluate most likely causes for patient symptoms will be guaranteed to misdiagnose causes for ailments, eventually.

Similarly, engineering design decisions may be influenced by cost, practicality, or other bureaucratic constraints that may include greed or other bias, such as a propensity not to be concerned with possibilities that have a low probability. For example, the transition of the United States military to purchasing commercial-off-the-shelf (COTS) parts was intended to reduce the cost of US military spending while maintaining reliability. The COTS purchasing strategy was intended to use newer, less expensive parts that had certain performance advantages over military specification (MIL-spec) parts that were more expensive, yet used older technology because of greater component reliability testing and sourcing requirements. Sometime after the COTS purchasing strategy was implemented, the US military realized that parts installed in fighter planes and in other equipment, included fake or fraudulent parts that did not even meet consumer reliability standards. Some of these fake parts would initially appear as if they did meet their consumer reliability specifications, yet would later deteriorate, where this deterioration could cause war fighter systems to fail after they were deployed in the field.

Artificial intelligent (AI) systems also suffer from limitations and bias. For example, an AI system may not consider the possibility of other diagnosis or the possibility that a COTS purchasing system can suffer from building fake parts into a machine. After all, computers and AI systems can only forecast or design based on how they were programmed, where humans, especially a swarm of humans have the potential to ‘think out of the box’ and may consider possibilities that have both low probabilities and high consequences.

Another limitation in AI systems relates to the fact that an AI system has no way of checking or testing that information received from individuals of a group is accurate. In instances where an AI systems retrieves or is provided inaccurate information regarding individuals in a group, any assessments or forecasts provided by that AI system regarding that group may likely be flawed. Fundamentally AI systems are also limited because they cannot collect additional information directly from members of a demographic or group of individuals.

Humans interpret the world in a different way than machines. In fact contextual information that humans use naturally are alien to machines. In a given situation, humans naturally identify contextual information implied by basic implicit assumptions that humans take for granted. For example, a wife may see her husband carrying a bag of groceries into the house: Did you buy me beer? For humans, the making the contextual association of a trip to the grocery store with the purchase of a commodity, such as beer, is natural. A machine observing the husband carrying a grocery bag, would not have a contextual reference that that bag really contained a consumable, nonetheless a consumable that could provide enjoyment when consumed.

Some of the differences between humans and machines are that humans can be emotionally driven where machines are not. For example, humans have been known to react emotionally and sell a stock because of a fear. Such fear based selling may then cause other inventors to also sell their stocks based on that fear. As such, un-tethered human emotions can and have caused panic selling based on an emotional apprehension. In contrast, machines incapable of panicking stock markets based on emotional fears or apprehensions. In another example male members of a combat group may behave irrationally and try to protect female soldiers in ways that are risky or foolish, where machines would not deviate from a course of action based on the gender of certain soldiers.

Differences between machine intelligence and human intallegence include differences in ‘context sensitive execution’ (consex) of machine ‘intelligence’ is by its very nature is different and alien to the consex of human intelligence. Machines, by their nature excel at computational tasks that are often associated with a limited number of constraints. Machines excel at tasks such as facial recognition and at playing chess, for example. Humans, in contrast, while are much better at understanding of a context of a give situation, where machines are not. For example, human driver driving a car may react differently in an instance where in an instance where another person walks in front of their moving vehicle as compared to an animal. In the instance were a person walks in front of the car driven by a human, the human driver is much more likely to take a more dangerous action, such as swerving into oncoming traffic, even when such an action may put the driver at risk of injury. The same driver driving under similar circumstances when an animal walks in front of their car may instantaneously discount the possibility of swerving into on-coming traffic and brake instead. Such reactions performed by a human may be performed instantaneously based on the natural human bias/context to hold human life to a higher degree than the life of an animal. A machine driven car would have no such context, to the machine an obstacle is an obstacle.

Each particular species of intelligence has biases and limitations. Many of these limitations relate to the fact that sensory systems associated with a particular form of intelligence do not have the capability of perceiving reality 100% accurately. Reality may also be difficult to interpret when a particular problem arises. This is especially true when that particular problem is complex and is not bounded by a limited or fixed set of rules. As such, when a problem has sufficiently complex and has uncertain rules or factors, one particular intelligence may be able to solve that problem at a given moment better than another form of intelligence. Humans can often quickly grasp a dangerous situation in a factory or mine from information interpreted in a context when machines are much less likely to identify that dangerous situation. This may be because machines may not be aware of contextual information that humans take for granted.

Another issue confronting humanity today is a rush to embrace technologies that are immature, that have a high level of complexity, and that are not bounded by a fixed set of rules. For example, there is a rush to user in the use of autonomous vehicles after only a few years of development and stock market traders are more and more reliant upon computer models that drive the buying and selling of stocks. One minor error or one minor miss-interpretation of contextual information can lead an AI system to cause a fatal vehicular crash or to drive the economy into a recession/depression via a stock market crash. Because of this, an overreliance on any one form of intelligence may cause actions to be initiated that have negative consequences, when an incorrect answer leads to inappropriate actions, the consequences could be very significant. As such, an overreliance on a particular type of intelligent species may lead to an incorrect answer as compared to systems and methods that review contrasting answers from different forms of intelligence to answer a question.

Based on the foregoing background information, AI or machine intelligence directed to forecasting how to reduce risks or provide warnings associated with a design or an anticipated potential root cause will likely be unreliable at least more frequently than systems and methods that that use both human and machine intelligence.

What are needed are systems and methods that identify answers that are more likely to result in a preferred outcome when complex problems that include sufficient uncertainty are being solved (where uncertainty here does not simply mean unknown, but, instead, the uncertainty of results from real world situations out of stochastic processes whose probability distributions are themselves in flux or changing, or out of the game playing of intelligent actors). What are needed are also systems and methods that combine human and machine intelligence in new ways or that identify instances when human intelligence and machine intelligence make contrasting forecasts or decisions.

### SUMMARY OF THE PRESENTLY CLAIMED INVENTION

Methods, non-transitory computer-readable medium, and apparatus consistent with the present disclosure relate to identifying factors that identify risk factors. A method consistent with the present disclosure may receive selections from user devices operated by human users that are associated with a user group and a subject. These methods may also receive information from an intelligent machine process, where that received information is associated with process includes a machine sentiment associated with the subject, identifying that the machine sentiment contrasts with the one or more human sentiments, and that issues a warning based on the machine sentiments contrasting with the one or more human sentiments.

When methods consistent with the present disclosure are implemented as a non-transitory computer-readable storage medium a processor executing instructions out of a memory may also receive information from an intelligent machine process, and identifying a factor that mitigates the effect of an obstacle that could prevent a statistically significant number of users from a first user group from committing to an offering. Here again the method may also include receiving information from an intelligent machine process, where that received information is associated with process includes a machine sentiment associated with the subject, identifying that the machine sentiment contrasts with the one or more human sentiments, and that issues a warning based on the machine sentiments contrasting with the one or more human sentiments.

An apparatus consistent with the present disclosure may include a network interface that receives selections from a plurality of user devices operated by users that are associated with a first user group, the received selections may be associated with a subject and one or more human sentiments. The user interface may also receive information from an intelligent machine process, where the information received from the intelligent machine process may include a machine sentiment associated with the subject. Such an apparatus may also include may also include a memory and a processor that executes instructions out of the memory to identify that the machine sentiment contrasts with the one or more human sentiments, and that issues a warning based on the machine sentiments contrasting with the one or more human sentiments.

### BRIEF DESCRIPTION OF THE DRAWINGS

FIG. 1 illustrates a computing device that receives answers from different user devices and from an artificial intelligence processing agent.

FIG. 2 illustrates a computing device that receives answers from different artificial intelligence processing agents.

FIG. 3 illustrates an exemplary computing system that may be used to implement all or a portion of a device for use with the present technology.

FIG. 4 illustrates an exemplary set of steps that may be performed by server implementing methods consistent with the present disclosure.

FIG. 5 illustrates a second set of exemplary set of steps that may be performed by a server implementing methods consistent with the present disclosure.

FIG. 6 illustrates a second set of exemplary set of steps that may be performed by a server implementing methods consistent with the present disclosure.

FIG. 7 illustrates an exemplary set of steps that may be performed at a user device.

FIG. 8 illustrates an exemplary set of steps that may be performed by a machine intelligent process.

FIG. 9 illustrates a computing system that may be used to implement an embodiment of the present invention

### DETAILED DESCRIPTION

Methods and systems consistent with the present disclosure identify useful ways or means of comparing and contrasting information from automated systems as compared to human inputs when identifying potential weaknesses in designs or other methods. This disclosure is also associated with identifying apparatus/systems and methods that combine the skills of humans at sensing and understanding unusual situations with the capabilities of machines and artificial intelligence (AI) to create a better more reliable type of warning system for practical application when attempting to improve outcomes, especially in situations where a high consequence is associated with a low probability. These systems and methods may also be useful in conditions where a negative outcome is associated with a high probability and where new perspectives can identify or lead to solutions or warnings that may lead to a positive outcome when those new perspectives are associated with a low or unknown success probability.

While AI systems may be good at computation, analytics and the like, at broad based, broad-spectrum, intelligence tasks, they are not well suited. To believe otherwise is contrary to all practical and objective tests of what AI can really do today, beyond trying to emulate human understanding and reactions. The old saying of two heads are better than one has merit, especially when stated in a more critical way: two heads are often better than one when making critical observations that may trigger alerts from a warning system.

This is especially true when considering failures associated with medical diagnosis, the failing O-rings in the Challenger disaster, and the Jon Jon Kennedy incident, where human error led to disaster. Each of these are exemplary instances where secondary systems did not assist in correcting an error of interpretation that may have been based as least in part on bias.

In the more mundane activities of day to day life, there are ample occasions when better or more-timely warning can help people avoid problems, danger, added expense and much else. On such occasions two heads or two instruments are often better than one, especially, if such systems/methods contrast and provide different points of view on a given situation.

Such is the case when one source of warning is out of a machine, AI or instrument, while the other comes from human perception and cognition; as these two forms are fundamentally alien to one another. Contrary to what is at times suggested in the popular press and other media, there may be precious little in common between what this or that machine ‘perceives’ and may ‘conclude’ and what humans come up with in similar situations. To think otherwise, is generally without proof or scientific basis. Humans are not of a kind with machines in cognition, and no one has yet identified the nature of human thought processes sufficiently to replicate anything of the sort in a computer or a robot.

AI machines, including computers, bots, chatbots, robots and the like are programmed devices whose outcomes are directly linked to input data. Such AI machines use models and algorithms that are pre-programmed to offer certain types of outcomes based on analytics, statistical analysis and ‘Big-Data’ processing, operating in an objective functional manner. In contrast to this, humans use their reasoning powers, their emotions, their intuition, their psychology and much else to arrive at anthropomorphic results and answers. Humans, therefore, are often as subjective as they are objective. Hence, dissimilar from the output of machines, which are limited, by their form and construction, to objective rational analysis of what they are by design programmed to accept as the real and the valid.

Put more succinctly, the ‘context sensitive execution’ (consex) of machine ‘intelligence’ is by its very nature different and alien to the consex of human intelligence. Wherein, the natural behavior of humans to engage in consex in their thoughts and actions does not correspond to much of anything even the most advanced, AI driven, machines do in similar ways, or are suitably equipped to perform.

What humans bring to the table is the complex product of atavistic evolution of psychological and other useful behavior traits beneficial to success and survival. What machine AI offers is fabulous computational and analytical skills and attendant memory, search and retrieval of useful information. The latter, AI approach, typically includes the outcomes and benefits derived out of so called machine learning systems, however well camouflaged they may be in order to seduce their audience.

Given all of the foregoing matter, an advanced warning system based on both man and machine intelligence, as in a Dual Consex Warning System, is likely to provide a more robust system, than one based on one or the other acting alone. While a system that conjoins the best of each in a harmonious way is likely to offer a more reliable warning system.

In stable predictable yet complex situations and analysis the advantages of AI systems can be significant in dealing with such problems or situations and thus offer great value. However, when surprises loom, uncertainty is afoot, or discontinuities come into play, such systems may be in need of rescue by other, perhaps less analytical more humanistic means. In these situations, the common failure of AI tools and algorithms is in its managing consex. This can lead to these AI machines not grasping the essential truth or context of a situation. Commonly this lack of contextual awareness or consex leads to a situation where AI machines get bogged down and that can lead to that AI machines offering foolish answers and poor suggestions to problems that humans can find practical real-world solutions to a problem.

The present disclosure is directed to a superior dual consex approach, where two alien streams of perception, analysis and choice of action come into play. One of these streams is machine mind based and the second stream is a stream of human consciousness. Members of the a human swarm may include experts of an “expert swarm” that can thrive when considering issues associated with a lack of good data, a lack of structure or a lack of a suitable model. Where similar situations may be disastrous to a “thinking” machine, human experts often thrive under such conditions. The practical uses of this approach are numerous including the following applications:
1: A Validation of Automation method that by the employment of queries obtains swarm results that can be used to validate the efficacy and utility of the design of an automated system or of an automaton.
2: A Testing Method that identifies possibly false results out of applications that employ functional algorithms and statistical methods, which may at times fail to grasp the true context of real-world situations.
3: An Unexpected Event Warning System, wherein the output of a trained swarm may conflict with automated or AI systems which at times may fail to properly warn of an impending problem or condition.
4: A system for Testing the Acceptability of automated systems, to determine whether their use by a population will result in a positive response across the layers of the systems features and functions as a service to humans.

Members of expert swarms may be selected from individuals that are members of qualified individuals, for example, in an instance when a person may require a procedure, such as tissue removal, be limited to members of a Board of Certified Physicians. In another example, engineers working on engineering designs, relating to building bridges or rocket engines, may be selected by identifying individuals that were licensed engineers or architects. Individuals of a particular swarm may also be selected based on education level, military training, or schools attended.

Now that the benefits of a Dual Consex Warning System are in somewhat fuller view, what remains to be grasped is how such a system can be made manifest in a convenient yet efficacious manner. That is, how best to bring into play the key advantages of machine-based cognition and human perception as needed to create a robust warning system. Perhaps it is best to keep it simple and focus on overcoming the shortcomings of each genre, by counterbalancing the strength of perception of each one to the other to affect a satisfactory outcome.

When a machine based system fails to provide a timely and effective warning of impending danger, it can be due to many factors, including:
1. A wrong-headed model or poor algorithm.
2. A discontinuity in the events space.
3. A high level of uncertainty or change.
4. Getting caught by surprise by events.
5. Poor or insufficient data.
6. A failure to set the correct context.
7. A poorly conceived criteria or value function.
8. Conditions overwhelming the machine's capacity.
9. Operator induced error.
10. Failures to grasp the scope or timing of things.
11. The AI not realizing when it is being played.
12. Getting outsmarted by a better opponent.

Based on cost-benefit considerations, each of these weaknesses in a warning system can be corrected to a degree. Nonetheless, all risk cannot be practically avoided. A better way may be the via a dual consex approach. However, when considering the contribution of humans to a warning systems, their rather substantial weaknesses must also be taken into account, including:
1. Being at times too easily distracted.
2. Engaging in multi-tasking and thus not being sufficiently alert.
3. Ideology and strongly held opinions coloring perceived reality.
4. Poorly placed over emotional reaction to factual input.
5. A tendency to react prematurely without sufficient information.
6. Giving up and turning away too quickly prior to fully grasping the situation.
7. Fatigue and loss of attention or concentration.
8. Two or more simultaneous factors or situation clouding the mind.
9. A failure to notice that the situation has changed.
10. A failure of intelligence to grasp the truth.
11. Ignorance, prejudice and plain carelessness.
12. The common failure to notice when one is being played by others.

With additional training, sufficient rest, proper habits and much else, much of this can be reduced or eliminated, but not it all, and not all of the time. Hence, over the objections of its management, airlines continue to ask the Federal Aviation Authority (FAA) to get rid of the co-pilot requirement in commercial aircraft, but the authorities wisely ignore their demand. At the same time, the high-tech folks suggest that tech answers abound to solve this problem. But are they right? Or is a dual consex system a more appropriate way to move forward?

In the present embodiment of a program application (APP) (currently referred to as the “Pumpable APP”) has been developed as with the intent of marrying operations performed by intelligent machines with the contrasting opinion of swarms of human experts to triangulate better results. This is true even when outputs from high tech instruments are used a inputs for analysis by algorithms by intelligent machines.

Systems and methods consistent with the present disclosure may only be done in situations where there is sufficient time for the human swarm to provide input to augment and supplement what the AI machine sensors and algorithms have offered or identified. This would work well at a nuclear power reactor, but not as well in the cockpit of a flying aircraft. It would seemingly work well to warn the operators of an oil refinery of an impending explosion, or of a looming danger in a commodity market, or of a problem in the management of a company. It might or might not be useful to a public servant's election committee. It would certainly be a powerful tool to use within machine learning training systems.

Solutions associated with this approach may be quite basic, where a selected subset of the weaknesses of man and machines are identified, and are used to supplement, augment, or to create suitable warning detection and action means considering the strengths and weaknesses associated with humans versus the strengths and weaknesses associated with machine intelligence. For example, if the failure to stay alert on the part of the human operator is the problem, then select a machine system to monitor and warn based on the person's eye and head movements, and the like. If, as is often the case with AI driven machines, it is a failure to grasp the context of a situation, use a swarm of individual humans to verify what the context actually is as input to the machine, and so on.

Systems and methods consistent with the present disclosure may contain a selected list of such pairs of machines supporting human actions and their opposite—the case wherein humans act to supplement machine systems. Such systems can be used to provide better warnings of dangers or promising opportunities or alternatives.

The disclosures of patent application Ser. No. 15/975,050, entitled “From Alien Streams” and patent application Ser. No. 16/017,740, entitled “From Sentiment to Participation” are incorporated by reference into this application. Patent application Ser. Nos. 15/975,050 and 16/017,740 are respectively related to provisional patent application disclosures 62/602,947 and 62/604,314 are also incorporated by reference into this application. Patent application disclosures 62/602,947; Ser. No. 15/975,050; 62/604,314; and Ser. No. 16/017,740 also related to contrasting information received from humans to information received from intelligent machines.

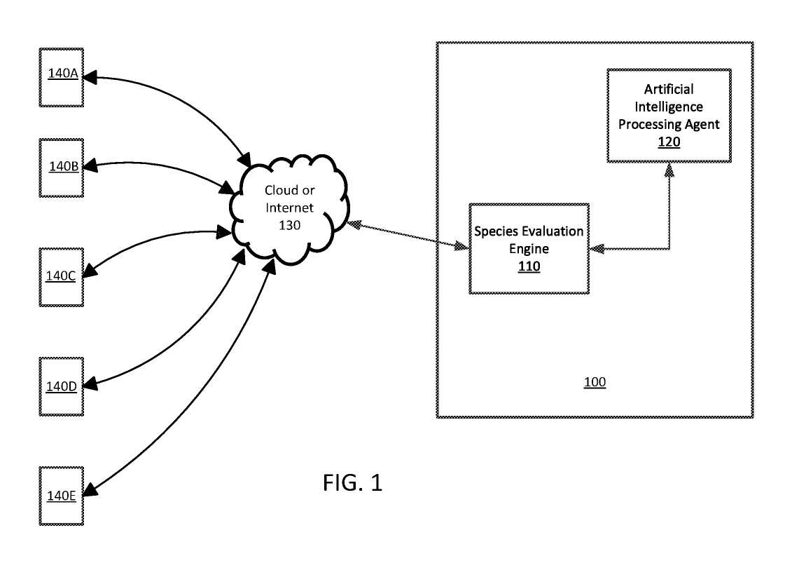

FIG. 1 illustrates a computing device that receives answers from different user devices and from an artificial intelligence processing agent. FIG. 1 includes species evaluation engine 110 that is communicatively coupled to a plurality of user devices (140A, 140B, 140C, 140D, and 140E) and from artificial intelligence processing agent 120. Each of the plurality of computing devices (140A-140E) are depicted as communicating with species evaluation engine 110 via the cloud or Internet 130. Each of computing devices 140A-140E may include processors that execute program code that may be associated with a web application, with a web browser, or with a downloadable application program.

Communications received by the species evaluation engine 110 may include information or answers to questions. For example, user device 140A may receive an answer to a question from a person using user device 140A and that answer may be transmitted over the cloud or Internet 130 to the species evaluation engine 110. Since people are members of the human species, the person using user device 140A can be considered a member of the human species. Similarly, persons using user devices 140B, 140C, 140D, and 140E may also be considered as members of the human species. The received information or answers may be used to identify a sentiment associated with one or more users of computing devices 140A-140E.

Information received from computing devices 140A-140E may include elections selected by users of devices 140A-140E, these elections may select options to provide perspectives from members of a human expert swarm in regard to management of a problem or may identify matters that should be considered in regard to an engineering project. Such user selections or elections may be to identify that particular users are engaged in a particular field or that identify concerns from expert individuals that can be leveraged to improve an outcome. For example, a doctor that is aware of new developments in a field of medicine may be more likely to identify potential treatments that improve outcomes because this particular doctor may be in possession of information not known generally by other doctors working the in field.

Species evaluation engine 110 may also receive information or an answer to a question from artificial intelligence processing agent 120. Artificial intelligence agent 120 is a form of intelligence that is not human, instead artificial intelligence agent 120 may be associated with a machine species of intelligence.

Note that FIG. 1 includes species evaluation engine 110 and artificial intelligence processing agent 120 within box 100. This indicates that processes performed by species evaluation engine 110 and processes performed by artificial intelligence processing agent 120 may be contained with a single machine device or computer 100. In such instances, one or more processors at machine device 100 may execute program code out of one or more memories when performing functions associated with species evaluation engine 110 or with artificial intelligence processing agent 120.

Alternatively species evaluation engine 110 and artificial processing agent 120 may be different devices that communicate with each other. In certain instances artificial processing agents may be implemented within more than one machine device including the device that performs functions consistent with species evaluation engine 110.

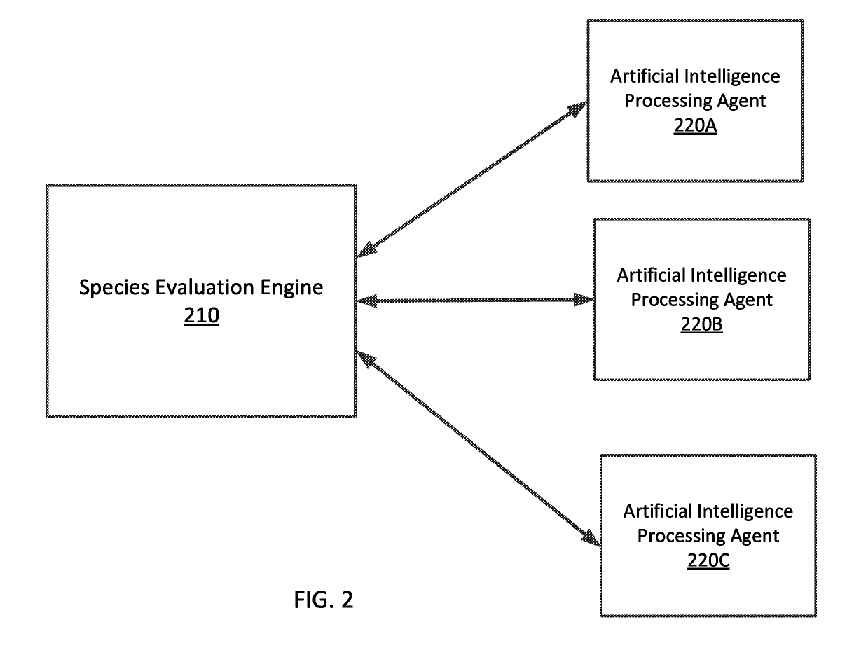

FIG. 2 illustrates a computing device that receives answers or information from different artificial intelligence processing agents. Note that species evaluation engine 210 may communicate with numerous different artificial intelligence processing agents 220A, 220B, and 220C of a machine species.

One or more of the artificial intelligence processing agents 220A, 220B, and 220C may be included within a single machine device with species evaluation engine 210. Additionally or alternatively one or more of the artificial intelligence processing agents 220A, 220B, and 220C may be included in one or more machines that are physically distinct from species evaluation engine 210.

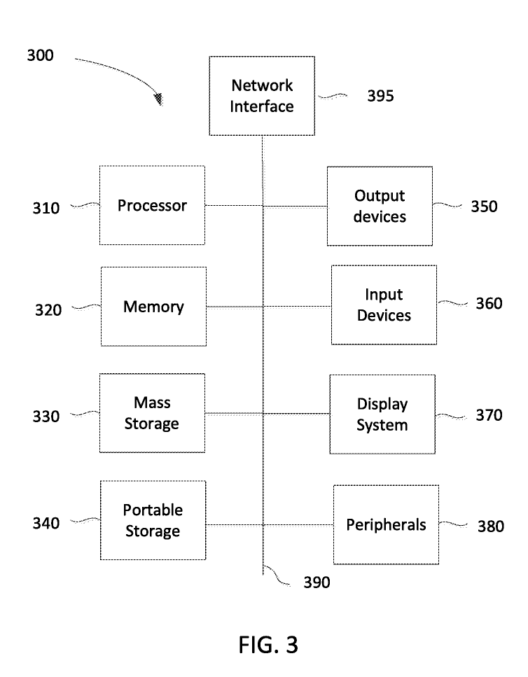

FIG. 3 illustrates an exemplary computing system that may be used to implement all or a portion of a device for use with the present technology. The computing system 300 of FIG. 3 includes one or more processors 310 and memory 320. Main memory 320 stores, in part, instructions and data for execution by processor 310.

Main memory 320 can store the executable code when in operation. The system 300 of FIG. 3 further includes a mass storage device 330, portable storage medium drive(s) 340, a GPS system 345, output devices 350, user input devices 360, a graphics display 370, peripheral devices 380, and a wireless communication system 385. The components shown in FIG. 3 are depicted as being connected via a single bus 390. However, the components may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses. Mass storage device 330, which may be implemented with a magnetic disk drive, solid state drives, an optical disk drive or other devices, may be a non-volatile storage device for storing data and instructions for use by processor unit 310. Mass storage device 330 can store the system software for implementing embodiments of the present invention for purposes of loading that software into main memory 320.

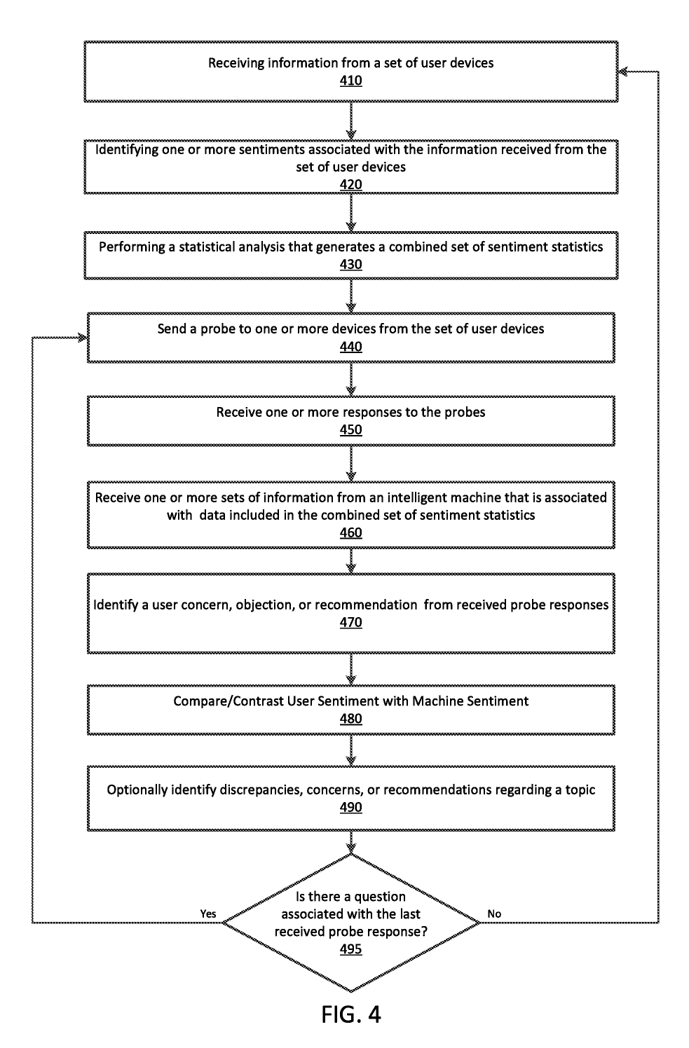

Portable storage device 340 operates in conjunction with a portable non-volatile storage medium, such as a FLASH thumb drive, compact disk or Digital video disc, to input and output data and code to and from the computer system 300 of FIG. 4. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 receives textual and graphical information, and processes the information for output to the display device.

Peripherals 380 may include any type of computer support device to add additional functionality to the computer system. For example, peripheral device(s) 380 may include a modem or a router.

GPS system 345 may include an antenna (not illustrated in FIG. 3) that receives global positioning information from one or more satellites such that a location associated with a current location of computer system 300 may be identified and provided to processor 310 via bus 390.

FIG. 3 also includes a wireless communication system 385 that may include an antenna (not illustrated in FIG. 3). Wireless communication system 385 may be configured to receive or transmit information via any standard wireless communication technology standard in the art. As such, wireless communication system 385 may receive or transmit information according to a wireless (2G, 3G, 4G, blue-tooth, 802.11, light strobes, or other) cellular or device to device standard, or may use radio or optical communication technologies. Wireless communication system may be configured to receive signals directly from pieces of infrastructure along a roadway (such as a signal light or roadway sensors), may be configured to receive signals associated with an emergency band, or may be configured to receive beacons that may be located at a service or emergency vehicle. Computer systems of the present disclosure may also include multiple wireless communication systems like communication system 385.

The components contained in the computer system 300 of FIG. 3 are those typically found in computer systems that may be suitable for use with embodiments of the present invention and are intended to represent a broad category of such computer components that are well known in the art. Thus, the computer system 300 of FIG. 3 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, and other suitable operating systems.

FIG. 4 illustrates an exemplary set of steps that may be performed by server implementing methods consistent with the present disclosure. Step 410 of FIG. 4 is a step where information may be received from a set of user devices. The information received in step 410 may be associated with a subject, a design, an engineering question, medical symptoms, or a medical diagnosis. In such instances users of the user devices may be experts in their field or hold engineering or medical degrees that will tend to indicate that their opinions and judgements relating to a particular field can be trusted. Each of these users may be associated with a field and with a human trust level.

For example, a selection relating to specifications relating to a bolt used in a crane, may be received from mechanical engineers. In another example, advice relating to optimizations of a manufacturing process, such as plasma etching may be received from a set of individuals that have experience with plasma etching. Users of such a set of user devices may have been classified or partitioned into a particular user group and information that those users provide via their devices may be associated with a human species stream of information regarding engineering design, a medical treatment, or scientific enquiry, for example. The information received in step 410 may include numerous play options that can be reviewed to identify that a user of a user device is engaged with a subject. The more intently a user responds to information displayed on a graphical user interface (GUI), for example, may be associated with a greater level of user engagement and interest in a subject. As such, sentiment may be obtained from users, they participate with a user interface or one or more GUIs upon which the user may act to impart his or her sentiment on the subject included in or associated with those GUIs. User sentiment may be identified by analyzing information that goes beyond just what user selections are made, as users could provide information by speaking words, making utterances, by typing text, or by writing on a user interface. Words or phrases identified in speech, utterances, texts, or in handwriting may be used to identify sentiment. For example, sentiment could be identified regarding an option associated with a desk and positive sentiments may be associated with written, spoken, or selected words or phrases, such as: wow; great; or fantastic; or no don't launch the rocket now —because you have not checked to see if the check list was complete. Negative sentiments could be associated written, spoken, or selected words of phrases, such as: no; get-outa-here; too expensive; or yuck, no don't launch the rocket now—because you did not check the fuel mix properly, for example.

Next in step 420 of FIG. 4 one or more sentiments relating to a subject may be identified. For example, a sentiment that a user of a certain type has been reviewing research papers for treating rats with adeno-carcinoma may be aware that a cannabinoid treatment combined with chemotherapy may be more beneficial than chemotherapy alone. This is actually a factual example, where Andy Hospodor PhD, a computer scientist, reviewed research papers when his friend was diagnosed with adeno-carcinoma of the pancreas. Dr. Hospodor found a study performed by Italian researcher Donadelli that reported that the CannabinoidReceptorl (CB1) ligand Rimonabant (SR141716, e.g. “SR1”) shrunk pancreatic cancer cells in mice. Adenocarcinoma cells are known to have many CB1 receptors, and THC is known to bind to CB1 receptors (i.e. THC is a CB1 ligand). Donadelli also discusses that cannabinoids when combined with Gemcitabine acts as autophagy and induce apoptosis in pancreatic cancer cells. Dr. Hospodor then formulated his own mendicants that were combined with Gemcitabine applications. This led to reduction of tumor mass and reduction in blood biomarkers indicative of cancer. Such treatment options may be identified based on one or more initial user selections or words collected in step 410 of FIG. 4. Such an example, indicates that individuals that do not have specific degrees in a particular field, may still be considered a relevant contributor. Such determinations may be based on facts or actions associated with such a user. For example, Dr. Hospodor had sufficient engineering training to be considered a trained individual, he has sufficient motivation to seek an out of the box solution, and he had access to information, including information from the University of California (where he worked), and he had access to oncologists that worked in the University of California San Francisco (UCSF) medical center and UC Davis. Dr. Hospodor also was overseeing the use of Big Data collected by the University of California with the mission of using computers to sort cancer treatment data collected by the UC medical system based on cancer genomic data and success rates. At this time the UC medical system had little or no data regarding using specific cannabinoids to treat specific forms of cancer. As such, methods and systems consistent with the present disclosure may be used in instances where certain problems are associated with a high likelihood of a undesired (negative) outcome and an unknown or a low probability of identifying alternative actions that could lead to a desired (positive) outcome.

In certain other instances user sentiments may be derived by capturing images of user reactions as they are provided media, for example. Here again an assessment regarding whether a user is engaged in a subject or in a set of media presently being provided, whether that media be audio, visual, interactive, or combination thereof can be used to identify user sentiment. Such information could include identifying media that the users review when considering how to achieve a best outcome when those users are identifying how to solve a problem. In such instances, users may provide references found that they believe to be relevant. Alternatively or additionally activity of the user may be tracked by an application program or other software installed on a computing device of the user. Furthermore, user's may be compensated for sharing certain data or for allowing their actions to be tracked when they were considering innovative engineering designs, identifying appropriate medical treatments, or searching for experimental data that is relevant to a certain issue or problem.

User sentiment in response to actions or media provided to a user may be used to filter or to classify users into a group or to collect statistics relating to sentiment. Step 430 of FIG. 4 is a step where a statistical analysis may be performed using sentiment information or statistics collected in step 420. This analysis may generate a combined set of sentiment statistics, for example.

In another example, engineering design information may be provided to user devices belonging to engineers familiar with bridge construction. As such, user responses of different sorts may be collected in step 410, where sentiments are identified in step 420, and analysis is performed in step 430. The analysis performed in step 430 may generate a set of probes or questions to send to user devices based on the data, sentiments and analysis. The probe requests could include additional media or could include textual or visual questions where answers could be provided by one or more means: selection, speaking, writing, or other. In certain instances, subsequent questions could be consistent with a theme associated with a preceding question. Alternatively, subsequent questions could contrast with the theme associated with a preceding question. The sentiments and questions could relate to building a bridge at a particular site and queries/questions sent to the user devices may relate design attributes regarding building a bridge that was strong, safe, and appropriate for environmental conditions in a cost effective way.

The probes are then sent to user devices in step 440 of FIG. 4. These probes could be tailored to specific individuals or to individuals of a group. For example, questions relating to features such as engine displacement, braking distance, braking surface, tire size, the presence or absence of a turbo, the presence or absence of a super charger, and the presence or absence of four wheel independent suspension could be sent to individuals associated with the design, building, or maintenance of vehicles. Queries/questions sent to such individuals could relate to building performance sports cars or to any other class of vehicle, including, but not limited to trucks, emergency vehicles, sport utility vehicles, or passenger cars. After the probes are sent, responses to those probes may be received in step 450 of FIG. 4.

Next in step 460 of FIG. 4 information may be received from an intelligent machine that may have identified preferred combinations of technical features that may relate to sentiments in the probes or questions sent to the user devices in step 440.

After step 460, step 470 may identify user concerns, objections, or recommendations from the received probe responses. For example, these responses may be directed to the design of a boat sinking prevention mechanism. Computer AI would be well suited to the task of identifying how much buoyancy must be present to prevent the boat from sinking, AI may also be well suited to identifying a volume of water that must be displaced within a boat to keep that boat from sinking below a threshold level when that boat was taking on water. Computers AI, however would likely not be able to anticipate how water could be displaced in a way that maintained safety for the crew in an event where the hull was breached when members of the crew were sleeping, for example. In such an instance, a machine intelligence might not consider how to maintain the safety of the crew in all conditions when a boat sinking prevention mechanism could be deployed. Certain mechanisms might trap a person in their bunk and this could potentially occur in a location below the water line of a compromised boat.

Next in step 480 user sentiments may be compared and contrasted with machine sentiments. Here again additional probes may be sent to users to help in a process that identified factors that address user concerns, objections, or recommendations. The machine intelligence sentiments received in step 460 when compared against the user (human) sentiment in step 480 may identify that the machine intelligence forecasted a volume of water that must be displaced to keep a particular boat from taking on above a threshold volume of water and the human swarm could provide information regarding the design of water displacement apparatus that would consume an internal volumetric space within a compromised boat that would be unlikely to impair or injure persons on board the boat.

Step 490 of FIG. 4 may identify a discrepancy, a concern, or a recommendation and program flow may move back to step 440 where additional probe requests may be sent to the user devices after which additional mitigating factors or reasons associated with user sentiment may be identified that may account for the discrepancy, concern, or recommendation. Step 490 may identify that a machine designed water displacement system was not safe enough based on feedback/probe responses from the human swarm. This identification may may be used to generate a warning that the design of a water displacement system in a boat sinking prevention apparatus should be designed with safety in mind. This warning and relevant information may be passed to designers of the water displacement system as that system is being designed.

Note in certain instances differences between 40% and 30% user/machine results may be considered not statistically significant, yet the differences between the 35% and 28% or between the 25% and 37% differences above may be considered statistically significant. As such an identification of a statistically significant percentage difference may be associated with a difference of greater than 5%. Since 35%-28%=7%; and since 37%-25%=12% are both greater than a threshold of 5%, these differences may be considered statistically significant.

Additional probe requests and user answers may be able to further clarify user objections and factors that mitigate those objections. As such, the determination of a water displacement apparatus that was safe.

Note that when step 495 does not identify different sentiments between machine and human outcomes or when such differences are not statistically different, program flow may move from step 495 back to step 410 where additional information may be received from the user devices. This could be based on a different set of conditions or be based on

After step 480, step 490, or additional user probes provided after step 495 may also identify concerns regarding the water displacement apparatus. In such instances information provided by an artificial intelligence system may identify a finding that external flotation combined with displacing water internally provided for greater safety because at least a portion of the cabin was free of both water and the displacement apparatus.

Steps consistent with the present disclosure could include fewer steps or more steps than those shown in FIG. 4. Queries, questions, or probes could be sent to user devices after any step. Step 460 may also be performed before step 410, or program flow consistent with the present disclosure may receive machine sentiment information at any time when processes consistent with the present disclosure are performed.

Methods and apparatus consistent with the present disclosure may also compare and contrast user/human preferences/sentiments with machine derived sentiments when forecasting build plans for vehicles. Machine intelligence alone or in synch with expert human intelligence or contrasts in expert human intelligence and machine intelligence may be able to identify an optimal preferred build plan for any design and can be applied to other technical subjects.

Such methods may use cost factors, statistical uncertainties, and experts of a very particular sort when making adjustments to build plans. Particular experts may include individuals that work in manufacturing, marketing, or sales of a company that produces cars, boats, airplanes, batteries, computers or any other product. These methods may also be applied to medicine or to the design of medical studies. Here again these experts may be tested. Such experts may provide sentiments from a perspective of production, overall efficiency, safety, cost, or other factors. These sentiments may be used to identify that a boat sinking prevention mechanism should include occupying 60% of an internal volume of a boat with a water displacement apparatus and include external flotation devices with specific volumetric dimensions that would prevent a compromised boat from sinking.

Embodiments of method and systems consistent with the present disclosure may, therefore, constitute a new hybridized form of intelligence that learns how to organize, prioritize, and make decisions regarding not only members within a given intelligent species, yet between different intelligent species. As such, systems and methods consistent with the present disclosure may make evaluations based on answers provided by one or more preferred members of a species. These decisions may be made to identify preferred members of the human species and/or to identify preferred member(s) of a machine species, for example. These decisions may also cause certain members of the human species to be removed from a set of human members when those certain members as associated with making poor recommendations or making recommendations that were later proven to be incorrect.

The invention may include a context tracking module in an attempt to capture the context sensitive execution (CONSEX) information associated with an artificial intelligence (AI) and that separately captures contextual information associated a particular swarm of human individuals as those individuals make evaluations and choices regarding a common subject. It is expected that both AI ‘bots’ (automated machines) and the swarm will at times show bias or a disconnect from reality, while the AI will tend to be more fact based yet at times ‘off putting’ and the human swarm will be prone to emotional, tribal, or have other biases. Information regarding a subject may be sent to members of a human swarm and responses relating to that information may be received from a statistically significant portion of those members. Queries regarding that subject may also be provided to a machine intelligence, after which answers may be received from the machine intelligence. The received information from the members of the human swarm may be compared or contrasted with the answers from the machine intelligence, where contrasting information may be used to identify questions to send to the human swarm members. After statistically significant numbers of responses have been received from the human swarm members, additional questions may be identified and sent to the machine intelligence. Next additional responses may be received from the machine intelligence, after which information associated with the human responses may be compared or contrasted with the additional responses received from the machine intelligence. As such, methods and systems consistent with the present disclosure may be iterative and include a series of steps where information received from human swarm members is compared to responses from a machine intelligence when ways or means of influencing a statistically significant number of the members of that human swarm to make a commitment are identified.

In an example of an iterative process consistent with the present disclosure, a machine intelligence may have been provided parameters regarding a medical condition. These parameters may include symptomatic information, genomic information, Xray's, magnetic-resonance-image scans, computerized tomography (CT) scans, ultrasound scans, blood test data, or other forensic information. The machine intelligence may then identify a condition, recommend possible treatment regimens, or identify additional test to perform on a patient based on the data provided. This data may also be shared with members of a human swarm and members of the human swarm may provide information that diverges from the findings or recommendations provided by the machine intelligence to a statistically significant degree. The machine intelligence could then be queried to re-evaluate available data to identify alternative possible treatment regimens from by mining research data associated with an unlikely condition that could potentially cause the particular symptoms or that is associated with an relatively new treatment that may be associated with a low or unknown success likelihood. Here again the divergent findings of an AI engine or machine intelligence from that of a human swarm may be a warning.

Note that contextual information relating to human concerns and recommendations may be compared or contrasted with context sensitive execution (CONSEX) information associated with a machine. A human species related swarm of data may include ways and means of capturing human related sentiment data. This human related sentiment data may be biased based on a demographic, a skill type, an education level, a level of concern, or may be related to other types of data types that are judged to be capable of providing reliable information regarding a problem. Such human related sentiment data may be stored in a database enabled accessibly by a processor executing program codes associated with a powerful statistical software program application/package.

Members of the human species swarm may earn internal human associated credits or tokens (HAT) based on their level of participation and success at making good choices. These credits may be stored in-house in a database or be stored at a third party computing device. In certain instances, particular individuals may earn non-monetary compensation, dividends, interest, credits payments, or other forms of compensation over time. In certain instances such compensation may at any time be converted by a swarm participant into a fungible crypto-currency. Individuals participating in a human swarm may not have or may never have had a bank account, as such, methods consistent with the present disclosure allow individuals to participate in a virtualized banking system where their crypto-currency earns interest over time. Non-monetary forms of compensation may include individuals being identified in publications or receiving or may include those individuals not being identified personally. For example, organizations and not individuals may receive forms of non-monetary compensation.

The method may include a sub-system for tracking confidence limits and classify confidence levels based on one or more types of levels of confidence error or success rates. For example, a Type I and Type II statistical errors made over time may cause a weighting factor assigned to a particular member of a species be reduced over time.

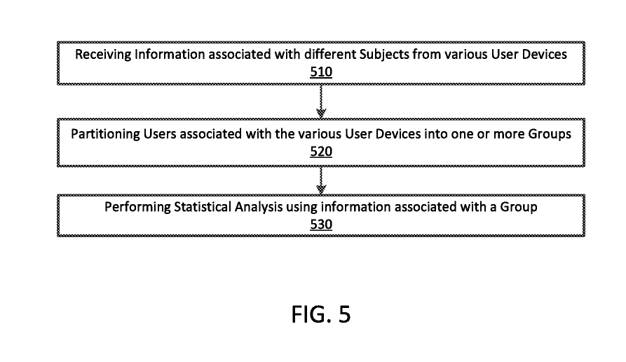

FIG. 5 illustrates a second set of exemplary set of steps that may be performed by a server implementing methods consistent with the present disclosure. Step 510 of FIG. 5 is a step where information relating to different subjects are received from different user devices. This received information may be used to partition sets of users into different groups in step 520, and a statistical analysis of information associated with particular groups could be used to perform a statistical analysis of a group in step 530 of FIG. 5.

The information received in step 510 may include information related to equipment design (vehicles, bicycles, camping equipment, computers, cell phones, boats, airplanes, bridges, or other products) or medical diagnosis/treatments. The information received from the users may be used to initially separate them into groups, where each different subject may include multiple groups. For example, engineering groups may include mechanical, electrical, computer, computer science, aerospace, or construction engineers. Similarly, users may be partitioned into groups of particular disciplines limited to type of computer memory: FLASH, disk drive, ferroelectric random access memory (FERAM), or conventional random access memories (RAM) for example.

The statistical analysis of step 530 of FIG. 5 may identify optional conditions for selecting FERAM instead of FLASH memory in a particular design, because FLASH is associated with a limited number of write cycle, where FERAM is not, for example. Alternatively step 530 may identify that a patient with symptoms of sciatica should also be tested for tumors when one or more other tests associated with identifying a root cause of sciatica have results that are inconclusive. Here again such a finding could trigger a warning to be sent to doctors that includes a recommendation to perform tests that could detect a tumor. This warning is associated with identifying a possible condition that is unlikely and that has severe consequences.

Such identifications may cause methods and systems consistent with the present disclosure to send questions to a user device when identifying why a user associated with that user device had an opinion or made a particular recommendation. Such questions and answers could be used to change a classification associated with a user. Such questions and answers may be used to identify certain percentages of chemists were more skilled at physics than many of the physics specialists in a classification. Such analysis could then be used to add those skilled chemists to the physics specialist classification or to remove poorly performing physics specialists from the physics specialist classification.

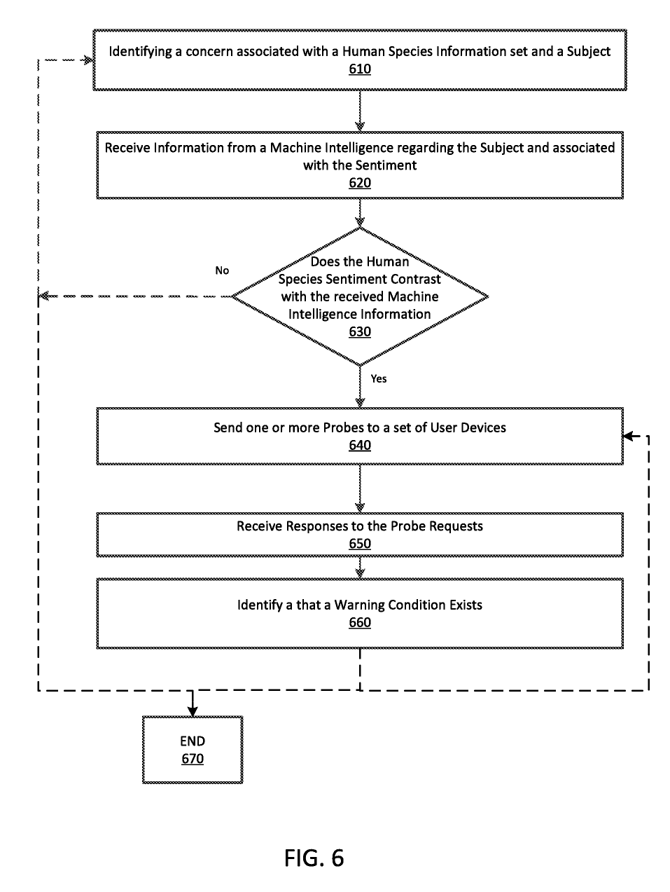

FIG. 6 illustrates a second set of exemplary set of steps that may be performed by a server implementing methods consistent with the present disclosure. Step 601 of FIG. 6 may identify a sentiment associated with as set of information associated with humans/people and a subject. Here again these sentiments may relate to user classifications or be related to actions performed by users of a group of users. Next in step 620 of FIG. 6 information regarding the subject and the sentiment may be received from a machine species. Then determination step 630 may determine whether the human species sentiment contrasts with the machine intelligence sentiment information, when no, program flow may move to step 610 where additional human sentiments may be identified or refined. Note that FIG. 6 indicates that when determination step 630 identifies that human sentiments do not contrast with machine intelligence sentiments, program flow may end at step 670 of FIG. 6.

When the human sentiment is found to contrast with the machine intelligence sentiment information program flow moves from step 630 to step 640, where probes or questions may be sent to user devices that belong to a group. Next in step 650 responses to the requests may be received. Next in step 660, possible mitigating factors associated with an identified or possible objection may be identified, after which program flow may flow back to step 640 where additional probes are sent to the user devices. Alternatively program flow may flow from step 660 to step 610 or end at step 680.

Here again inputs and queries may be used to identify contrasting information when identifying that a warning condition exists.

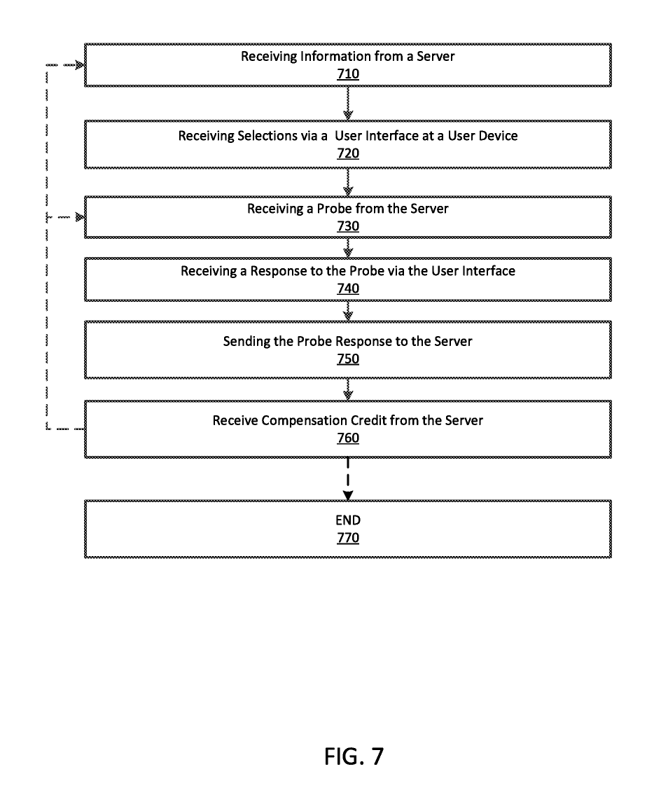

FIG. 7 illustrates an exemplary set of steps that may be performed at a user device. Step 710 of FIG. 7 is a step where information is received from a server. This information received from the server may be a webpage, maybe a program application, or may include any form of media. Next step 720 may receive selections via a user interface at a user device. These selections may be associated with safety, engineering, medicine, or science. For example, a scientific enquiry into how to safely deal with nuclear waste could be conducted by comparing the results of a machine intelligence with information from a human swarm. The machine intelligence may be able to identify parametrics or forecasts regarding the long term safety of storing nuclear waste in a particular way. Where forecasts could relate to hydrogen gas accumulation or decay rates of storage tanks. Members of the human swarm may then be directed to identify ways to mitigate hydrogen accumulation or to identify how at least some of that waste could be consumed in a nuclear reactor in a timely way. After the user makes selections, probes may be received by a user device associated with a user of a user group in step 730. The users of the user group may receive question probes regarding particular design features and what different user of a user group like or do not like about those features or such users may identify risk factors associated with a particular approach. Alternatively or additionally, user devices may receive probes that include interactive media that the user can make additional selections regarding. Probes associated with a lead user may be sent to a group of user devices from a server, when methods consistent with the present disclosure are performed.

After the probe is received, responses to those probes may be received via a user interface or a microphone that a user interacts with in step 740 of FIG. 7. Alternatively or additionally visual responses may be captured by a camera at the user device when program code at a user device identifies possible subjective sentiments of a user based on a visual reaction of a user. Next in step 750 the response or an interpretation of the response may be sent to the server. Since responses may include spoken words, texts, or visual reactions, sentiments associated with a response may interpreted from these words and reactions by software operating at the user device.

After step 750, a user device may receive compensation from the server in the form of a credit or in the by means of a crypto-currency transaction. The received compensation may be based on participation of the user of the user device (where greater participation may yield greater levels of compensation), may be based on identifying warning conditions associated with a low probability and with a high risk factor. Alternatively or additionally warnings could be associated with a projected outcome that is negative when an unlikely or a previously unanticipated potential alternative solution is identified. For example, studies performed on test animals may be applied to humans when the consequences of a particular ailment are dire or deadly.

The levels of compensation that users receive may be based on a determination that a particular user has provided feedback that proves to be statistically significant over a group of users of a special group of individuals. For example, a user that first provides over a threshold number of new supportable hypothesis regarding transformational treatment regimens may be provided enhanced compensation in step 760 of FIG. 7. A user that first identifies an recommendation that proves to be statistically significant may also be provided enhanced compensation. Alternatively or additionally a user that provides a mitigating factor or set of mitigating factors relating to risk that proves to be statistically significant may be provided with enhanced compensation. Individuals that consistently provide statistically significant results may be promoted, and such promotions may enhance their ability to earn compensation. In contrast individuals that do not provide enough statistically significant or important information may be demoted (receive less compensation for a given level of participation or other metric) or be removed from a group. After step 760 program flow may move to step 730 where additional probes may be received, may move to step 710 where additional information may be received from the server, or may move to step 770 where program flow may end.

Since an aspect of the present disclosure includes keeping information associated with different species separate, methods and apparatus consistent with the present disclosure may perform tests that identify whether answers coming from a particular source are really coming from a correct species. For example, in an instance where a hacker provides an AI engine (or bot) to provider answers for them as a member of the human species, the actions of that hacker would tend to corrupt the very purpose of systems consistent with the present disclosure. Because of this, a user device may be sent questions that are more likely to be answered by humans better than machines. In such instances a user device may display a group of photographs, some of which include store fronts and the user may be polled to select which photos of that group include the store front. When a group of correct photos are entered via the user interface and are received by a species evaluation engine, that species evaluation engine can identify that answers received from that user device were really provided by a member of the human species. Such a test is merely exemplary as any test that humans are more likely to answer correctly as compared to a member of a machine species may be used to identify whether a certain entity is really a human or not.

Test relating to identifying whether a particular response provider is truly of the human species may also include tests associated with identifying human emotions, senses, and intuition. An exemplary test may include providing visual or audio information or stimulus to a user device for presentation to a user via a display or a speaker of a user device. Pleasant images or music may be displayed or played to a user after which one or more responses may be provided by or received from the user device. The user interacting with a user interface of the user device may provide indications or responses identifying that the currently displayed images or music is pleasant. Alternatively or additionally unpleasant images or sounds may be displayed or played to a user via the user device and an indication that the displayed or played content may be received from the user device. For example, a blasting siren or other unpleasant sound, if cancelled or shut off within a threshold time could indicate that the user device was being operated by a real human based on their quick action to shut down an unpleasant sound (or image).

In yet other instances, sensors or camera at a user device may be used to view a user or to measure a physiological response from a user as that user is provided pleasant and/or unpleasant images or sounds. Physiological responses, such as movements (backing away, looking away, or paying closer attention), changes in heart rate, changes in perspiration rates, or changes in a respiration rate. As such, user devices associated with the present disclosure may also include cameras or sensors that sense human responses to stimulus provided via a display or speaker.

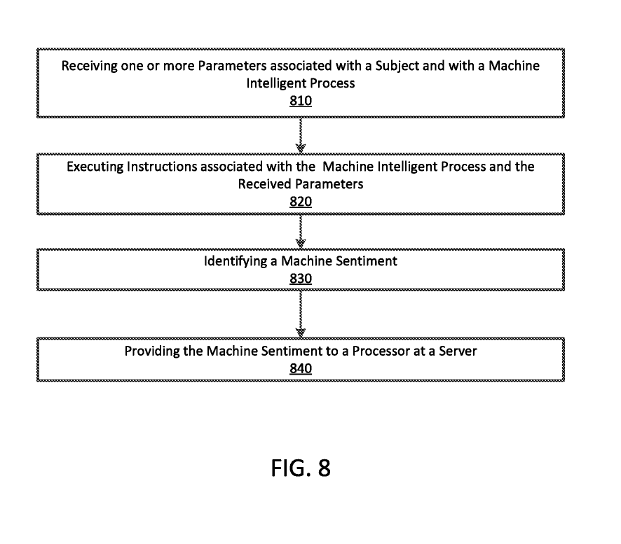

FIG. 8 illustrates an exemplary set of steps that may be performed by a machine intelligent process. FIG. 8 includes step 810, where one or more parameters associated with a subject and an intelligent machine process is provided to the intelligent machine process. The subject may be related to trains, for example. The machine process may perform calculations associated with a computer model or other machine construct. This machine process may identify types of air-taxis and features or sets of features that may be associated with those air-taxis based on the parameters. The parameters may be associated with size, wieght, distance, speed, vertical takeoff capabilities, or other metrics. Next in step 820 of FIG. 8 the machine process may by implemented by a processor executing instructions out of a memory using the received parameters, such that a machine sentiment may be generated/identified in step 830. Finally in step 840 of FIG. 8, the machine sentiment may be provided to a processor at a server. In certain instances, the processor performing the steps of the machine process may be included in a sever that communicates with user devices. Alternatively or additionally, the processor performing the machine process may provide the machine sentiment to the processor at the server via a network interface. The method of FIG. 8 may be included within or be coupled to methods and apparatus consistent with the other figures of this disclosure.

Method and apparatus consistent with the present disclosure may be used to improve the accuracy of an intelligent machine process, thereby, improving the operation of computers and computer models. In such instances, information relating to an obstacle or a mitigating factor may be incorporated into the intelligent machine process. The information provided may be in the form of parameters that relate to the obstacle or the mitigating factors, treatments, engineering designs, safety margins, or science experiments may be incorporated into a computer model that forecasts future events or that forecasts human behavior.

In certain instances, differences identified between different streams of information may or may not be statistically significant. An AI stream could indicate that a stock should be built with cables rated at holding 100 thousand tons and a human stream could indicate that the stock should be capability of holding 90 thousand tons, yet the human stream could include attributes that associate the stock with a weak buy position. As such, the results may be evaluated with metrics of weakness or strength associated with the human stream. For example, when 510 of 1000 of user responses may indicate that the 90 thousand ton cables should be used and that 490 of the user responses indicated that 100 thousand ton cables be used. In such an instance the difference between the two streams may be considered not statistically significant. In such instances, the human swarm may be associated with a threshold ratio of confidence associated with the different cable strength recommendations from the human swarm. A threshold percentage of 100 thousand ton recommendations may be found to be more appropriate based on factors associated with some of the human respondents when a statistical analysis or historical analysis is performed. Alternatively, threshold ratios or percentages or statistical/historical analysis may be used to identify strong or weak recommendations. Statistically significant differences may be associated with data sets that are large enough to represent populations of information that provide an indication that is greater than a threshold level that may be associated with ratios, percentages, chances, probabilities, error rates, or a significance level. The statistical significance of a set of human responses or a preferred human response may be associated with a certainty level. For example, a certainty level associated with human query responses or with a preferred human query response that is related to a number of human responders, users, with weights associated with favored human responders, or with a sample size that is greater than a margin of error. A preferred human response may be considered statistically significant when a preferred human query response is at or above a statistical threshold.

Biases of particular individuals or streams of information (machine/AI stream or a human stream) may also be identified. Biases may be associated with an offset, for example in an instance where a stream or an individual provides responses that are associated with a magnitude, if that magnitude is within a threshold distance of an absolute correct answer magnitude, then such responses may be identified as being correct, just offset from particular correct response. Such a user or stream may then be judged as correct, yet biased. Such a bias could be identified and used when making buy or sell decisions according to methods consistent with the present disclosure.

Methods and apparatus of the present disclosure may also include information relating to real-world contextual information or information associated with the physical world. For example, a human stream may provide information regarding the weather where users are located. Indications can be received from user devices as part of a regional stream associated with a locality (city, state, or other location). These indications could identify that the weather is getting better or worse. That a tornado is approaching or moving away from my neighborhood, that rain is increasing or decreasing, that a river is rising or lowering, that flood waters are getting higher or are abating, that winds are increasing or decreasing, or that fire is moving in a certain direction. This human stream may be contrasted with a weather prediction stream that predicts the course of a storm and could be used to issue alerts to areas identified with risk to life or property with greater certainty. Machine intelligence may benefit from information sensed by sensing stations, by Doppler radar, or by infrared or other instrumentation, for example, when assessing whether and where risk reports or evacuation orders should be issued. Alternatively, a human stream may be associated volatility of a region of the world based at least in part on observations made by individuals in a particular locality. Sensor data that senses loud noises, smoke, or other disruptions may be use by a machine intelligence when identifying weather an area should be associated with a risk. As such, real world information provided by users can be contrasted with information from AI systems when validating that a risk is real, where a sophisticated enough AI system may be able to identify the location of a particular risk based on sensor data.

As much as humans and intelligent machines are different species, different members of the animal kingdom are also different species from either humans or intelligence species that are each alien from each other. The universe at large may also include beings that are forms of intelligent species that are alien to humans, animals, or intelligent machines.

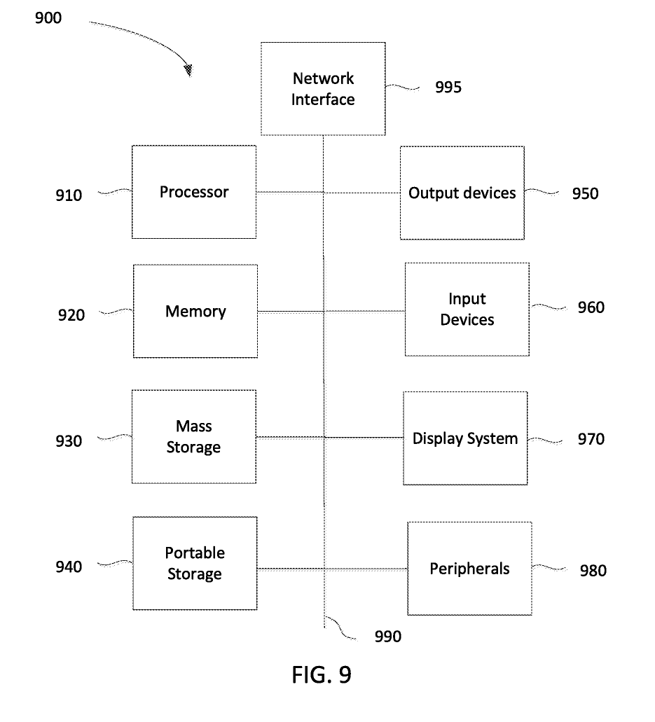

FIG. 9 illustrates a computing system that may be used to implement an embodiment of the present invention. The computing system 900 of FIG. 9 includes one or more processors 910 and main memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, peripheral devices 980, and network interface 995.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive or an optical disk drive, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a FLASH memory, compact disk or Digital video disc, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, or a pointing device, such as a mouse, a trackball, stylus, or cursor direction keys. Additionally, the system 900 as shown in FIG. 9 includes output devices 950. Examples of suitable output devices include speakers, printers, network interfaces, and monitors.

Display system 970 may include a liquid crystal display (LCD), a plasma display, an organic light-emitting diode (OLED) display, an electronic ink display, a projector-based display, a holographic display, or another suitable display device. Display system 970 receives textual and graphical information, and processes the information for output to the display device. The display system 970 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 980 may include any type of computer support device to add additional functionality to the computer system. For example, peripheral device(s) 980 may include a modem or a router.

Network interface 995 may include any form of computer interface of a computer, whether that be a wired network or a wireless interface. As such, network interface 995 may be an Ethernet network interface, a BLUETOOTH™ wireless interface, an 802.11 interface, or a cellular phone interface.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 900 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for identifying risk factors, the method comprising:
receiving selections from a plurality of user devices operated by users that are associated with a first user group, the received selections associated with at least a first subject and one or more human sentiments;
receiving information from an intelligent machine process, wherein the information received from the intelligent machine process includes a machine sentiment associated with the subject;
identifying that the machine sentiment contrasts with the one or more human sentiments; and
issuing a warning based on the machine sentiments contrasting with the one or more human sentiments.

2. The method of claim 1, further comprising:
performing a statistical analysis on one or more human sentiments;
sending one or more probes to the plurality of user devices, the one or more probes associated with identifying a warning condition;
receiving responses to the one or more probes sent to the plurality of user devices;
evaluating the received probe responses; and
identifying a course of action that mitigates the warning condition, wherein the course of action prevents a negative outcome associated with the warning condition and the warning.

3. The method of claim 1, further comprising identifying one or more parameters to associate with the intelligent machine process, wherein:
the selections received from the plurality of users and the information received from the intelligent machine process are associated with a first iteration of interactions with the users of the first user group and with the intelligent machine process;
the one or more parameters are related to a warning condition;
the one or more parameters are incorporated into the intelligent machine process to improve the accuracy of the intelligent machine process as part of a second iteration of interactions with the users of the first user group and with the intelligent machine process; and
subsequent executions of the intelligent machine process are performed in accordance to the one or more parameters related to a warning condition

4. The method of claim 2, wherein the evaluation of the received probe responses includes:
identifying that the probe responses include responses that indicate that at least some of the users from the first user group have identified a risk factor;
performing a statistical analysis to identify whether at least one probe response is statistically significant;
sending additional probes to user devices associated with the at least one probe response, and
receiving responses to the additional probes sent to the associated user devices, wherein a factor that can mitigate the risk factor is identified.

5. The method of claim 1, further comprising:
identifying a level of participation associated with each of the users from the first user group;
calculating a compensation to provide to a first user from the first user group; and
providing the compensation to a user device associated with the first user.

6. The method of claim 1, further comprising:
identifying one or more users that identified a risk factor associated with the warning within a first time period;
sending additional probe requests to the at least one or more of the plurality of user devices operated by the users from the first user group;
receiving responses to the additional probe requests;
performing a statistical analysis;
identifying from the statistical analysis that the risk factor is statistically significant; and
providing a compensation to the one or more users based on the one or more users identifying the risk factor within the first time period and based on the identification that the risk factor is statistically significant.

7. The method of claim 1, further comprising:
calculating compensation amounts to provide to one or more users from the first user group, the calculation associated with at least one of an amount of participation associated with the one or more users, one or more sentiments received from user devices associated with the one or more users that prove to be statistically significant, or one or more responses received from the one or more user devices that prove to be statistically significant; and
providing the compensation to each of the one or more user devices in accordance with the calculated compensation amounts.

8. The method of claim 1, wherein the subject relates to at least one of an engineering design, a medical treatment, a medical condition, or a inquiry in a scientific field.

9. The method of claim 1, further comprising:
identifying a user from the first user group that is associated with a performance level that is above a threshold level of performance; and
increasing a compensation rate associated based on the identification that the user from the first user group performed at a level that is above the threshold level of performance.

10. A non-transitory computer readable storage medium having embodied thereon a program executable by a processor for identifying risk factors, the method comprising:
receiving selections from a plurality of user devices operated by users that are associated with a first user group, the received selections associated with at least a first subject and one or more human sentiments;
receiving information from an intelligent machine process, wherein the information received from the intelligent machine process includes a machine sentiment associated with the subject;
identifying that the machine sentiment contrasts with the one or more human sentiments; and
issuing a warning based on the machine sentiments contrasting with the one or more human sentiments.

11. The non-transitory computer readable storage medium of claim 10, the program further executable to:
perform a statistical analysis on one or more human sentiments;
send one or more probes to the plurality of user devices, the one or more probes associated with identifying a warning condition;
receive responses to the one or more probes sent to the plurality of user devices;
evaluate the received probe responses; and
identify a course of action that mitigates the warning condition, wherein the course of action prevents a negative outcome associated with the warning condition and the warning.

12. The non-transitory computer readable storage medium of claim 10, the program is further executable to identify one or more parameters to associate with the intelligent machine process, wherein:
the selections received from the plurality of users and the information received from the intelligent machine process are associated with a first iteration of interactions with the users of the first user group and with the intelligent machine process;
the one or more parameters are related to a warning condition;
the one or more parameters are incorporated into the intelligent machine process to improve the accuracy of the intelligent machine process as part of a second iteration of interactions with the users of the first user group and with the intelligent machine process; and
subsequent executions of the intelligent machine process are performed in accordance to the one or more parameters related to a warning condition

13. The non-transitory computer readable storage medium of claim 11, wherein the evaluation of the received probe responses includes:
identifying that the probe responses include responses that indicate that at least some of the users from the first user group have identified a risk factor;
performing a statistical analysis to identify whether at least one probe response is statistically significant;
sending additional probes to user devices associated with the at least one probe response, and
receiving responses to the additional probes sent to the associated user devices, wherein a factor that can mitigate the risk factor is identified.

14. The non-transitory computer readable storage medium of claim 10, the program is further executable to:
identify a level of participation associated with each of the users from the first user group;
calculate a compensation to provide to a first user from the first user group; and
provide the compensation to a user device associated with the first user.

15. The non-transitory computer readable storage medium of claim 10, the program is further executable to:
identify one or more users that identified a risk factor associated with the warning within a first time period;
send additional probe requests to the at least one or more of the plurality of user devices operated by the users from the first user group;
receive responses to the additional probe requests;
perform a statistical analysis;
identify from the statistical analysis that the risk factor is statistically significant; and
provide a compensation to the one or more users based on the one or more users identifying the risk factor within the first time period and based on the identification that the risk factor is statistically significant.

16. The non-transitory computer readable storage medium of claim 10, the program is further executable to:
calculate compensation amounts to provide to one or more users from the first user group, the calculation associated with at least one of an amount of participation associated with the one or more users, one or more sentiments received from user devices associated with the one or more users that prove to be statistically significant, or one or more responses received from the one or more user devices that prove to be statistically significant; and
provide the compensation to each of the one or more user devices in accordance with the calculated compensation amounts.

17. The non-transitory computer readable storage medium of claim 10, wherein the subject relates to at least one of an engineering design, a medical treatment, a medical condition, or an inquiry in a scientific field.

18. The non-transitory computer readable storage medium of claim 10, further comprising:
identifying a user from the first user group that is associated with a performance level that is above a threshold level of performance; and
increasing a compensation rate associated based on the identification that the user from the first user group performed at a level that is above the threshold level of performance.

19. An apparatus that identifies factors that mitigate objections in a demographic group, the apparatus comprising:
a network interface that receives selections from a plurality of user devices operated by users that are associated with a first user group, the received selections associated with at least a first subject and one or more human sentiments and that receiving information from an intelligent machine process, wherein the information received from the intelligent machine process includes a machine sentiment associated with the subject;
a memory; and
a processor that executes instructions out of the memory to:
identify that the machine sentiment contrasts with the one or more human sentiments; and
issue a warning based on the machine sentiments contrasting with the one or more human sentiments.

20. The apparatus of claim 19, wherein:
perform a statistical analysis on one or more human sentiments;
send one or more probes to the plurality of user devices, the one or more probes associated with identifying a warning condition;
receive responses to the one or more probes sent to the plurality of user devices;
evaluate the received probe responses; and
identify a course of action that mitigates the warning condition, wherein the course of action prevents a negative outcome associated with the warning condition and the warning.
